(19) United States
(12) Patent Application Publication
(10) Pub. No.: US 2020/0389765 A1
(43) Pub. Date: Dec. 10, 2020

(54) Method and Apparatus for Personal Transportation Vehicle Locator

(71) Applicant: Lance Bridges, La Jolla, CA (US)

(72) Inventor: Lance Bridges, La Jolla, CA (US)

(21) Appl. No.: 16/896,824

(22) Filed: Jun. 9, 2020

Related U.S. Application Data
(60) Provisional application No. 62/859,550, filed on Jun. 10, 2019.

(51) Int. Cl. H04W 4/029; B62M 6/40; B62J 3/00; B62J 6/028; B62J 6/04; G08C 17/02

(52) U.S. Cl. CPC H04W 4/029; B62M 6/40; G08C 17/02; B62J 6/028; B62J 6/04; B62J 3/00

(57) ABSTRACT

A finding system for locating a bicycle, e-bike, scooter or other personal transportation vehicle within localized area. The system comprises a handheld radio transmitter which, when actuated by a user, sends a signal to a receiver unit affixed to the vehicle. Upon receiving the signal, an alert output device coupled to the receiver unit will emit a beacon signal permitting the user to find the vehicle. The beacon signal may be an audible signal (a bell, beep, chirp, buzz, tone, whistle, horn or siren) and/or a visual signal (such as flashing LED lights or a flashing taillight or headlight).

### CROSS REFERENCE TO RELATED APPLICATIONS

The present application claims priority to U.S. Patent Provisional Application No. 62/859,550 filed on Jun. 10, 2019, entitled “Method and Apparatus for Personal Transportation Vehicle Locator”, the contents of which is herein incorporated by reference in its entirety.

### BACKGROUND

### (1) Technical Field

The disclosed method and apparatus relate generally to systems for finding a stationary lost object. In particular, the disclosed method and apparatus relates to transmitters and receivers, that in some instances activate acoustic or visual search signals to assist in finding the object.

### (2) Background

Individual personal transportation vehicles, such as traditional pedal-bicycles, electric bicycles (i.e., e-bikes) and folding electric scooters, are ubiquitous in places, such as crowded urban centers, college campuses and mass transit hubs. These vehicles are a favorable alternative to cars, trucks and even motorcycles and gas-powered scooters, because they are quieter, more eco-friendly and they take up less space to park and use. Nonetheless, such personal transport vehicles generally may not accompany the rider indoors and must be parked and locked on a curb, sidewalk or specific area designated for such vehicles (such as a dock, rack or corral). When many such vehicles are grouped together near each other, and particularly when the vehicles look alike, it may become difficult for a rider to quickly identify his or her bike or scooter. This difficulty is exacerbated in low-light conditions, such as at night. This can lead to significant time lost trying to find a particular bike or scooter, which can be particularly frustrating when the rider is ready to be on his or her way. Personal safety may also be an issue when a preoccupied individual can't find the bike or scooter in an unlit street or curb at night.

For example, Holland is a flat country with old, narrow streets that predate the automobile in most urban centers. The Dutch have a strong biking culture and have developed a specific type of bicycle—the “city bike”—that most people use for daily transportation instead of cars. These bikes all look very similar to each other. On any city block in Amsterdam, you will see dozens of very similar looking bikes clustered together, parked and locked in dense, virtual islands of bikes. If you go to a train station or ferry terminal, there are hundreds of such bikes parked together in tight clusters. Frequently, people are unable to quickly find their bikes and this has become a common problem. The same problem exists on a smaller scale on college campuses in the USA, though one big difference is that bikes here are more varied and unique, which can be a big help in finding a particular bike. On the other hand, where bike sharing programs are gaining prominence, the United States is moving towards the situation similar to that found in Holland, where all vehicles in the same sharing program look identical and it can be difficult to find a particular bike or scooter.

Accordingly, the same problem may exist in such cases in which a user is attempting to identify a particular bike or scooter as part of a bike and scooter sharing program, in which a particular bike or scooter to be reserved in advance and which require the rider to locate that specific bike or scooter in a local area that can only be approximated through GPS coordinates provided to the rider through the sharing app.

Accordingly, for all these cases, there is currently a need for a way to quickly and efficiently find a particular bike or scooter that is located in a known local area in which there may be many similar vehicles are parked.

### SUMMARY

Various embodiments of a method and apparatus for vehicle location are disclosed in which techniques and features are employed to assist an owner or user of a personal transportation vehicle to identify a particular vehicle from among several other identical or similar looking vehicles.

The disclosed method and apparatus can be applied to vehicles provided by shared-vehicle services that provide urban transportation solutions—for example, scooters and e-bikes that are rented by the hour in self-serve, dockless bike/scooter sharing programs, such as those offered by Jump by Uber, Lime or Bird for either various personal transportation vehicles. Jump currently provides a feature whereby a customer can reserve a bike or scooter, rather than having all vehicles available on a walk-up, first-come-first-served basis. With a reserved vehicle, it may be necessary for the person that reserved the vehicle to find the particular vehicle that was reserved.

Some embodiments of a system for finding a personal vehicle may comprise one or more transmitters and one or more receivers. In such embodiments, the transmitter is portable and the receiver is affixed to the vehicle the user wishes to find. Transmission of a search signal from at least one transmitter causes at least one of the receivers to emit a beacon signal, such as an audible signal and/or a visual signal, such as a flashing light, enabling the user to find the receiver and the vehicle to which the receiver is attached. In some embodiments, the receiver may be integrated into a bell, a headlight, a taillight, the frame of the vehicle or a frame lock or wheel lock.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a plurality of bicycles

FIG. 2 is an illustration of another embodiment in which at least one of a plurality of bicycles can be identified by remotely activating one or more lights, such as a headlight and/or taillight.

FIG. 3 is a simplified block diagram of the components of a personal transportation vehicle, such as a bicycle.

FIG. 4 is an illustration of an embodiment in which a frame lock having receiver can receive signals from a remote source to both unlock the bicycle and also make either an audible or visual indication to identify the bicycle of interest.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

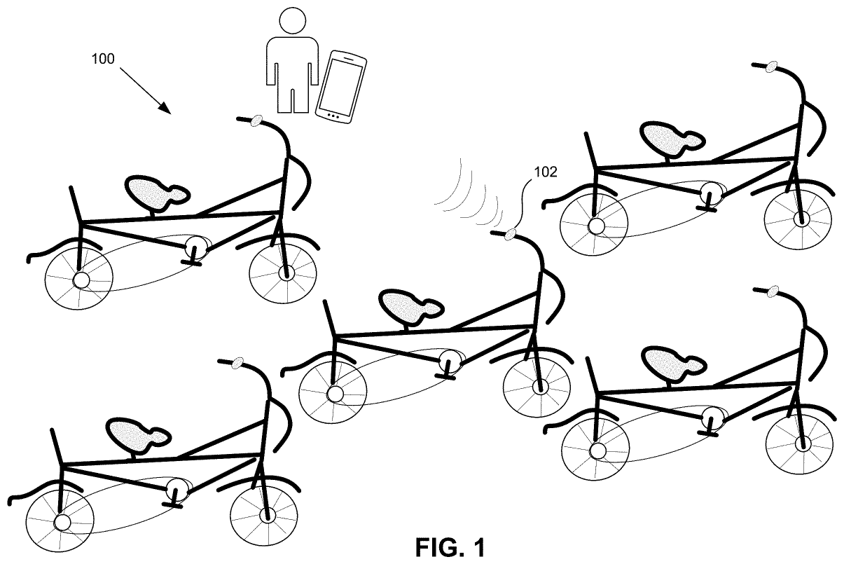

FIG. 1 is an illustration of a plurality of bicycles 100. At least one of the bicycles 100 is equipped with an alert output device, such as an electronic bell 102 that can be remotely activated to assist in identifying the bicycle on which the bell is mounted. In some embodiments, the alert output device can be activated by a person 104 using an application running on a cellular phone 106. In some such embodiments, the alert output device can also be activated mechanically by the rider through the use of a mechanical switch or other similar means.

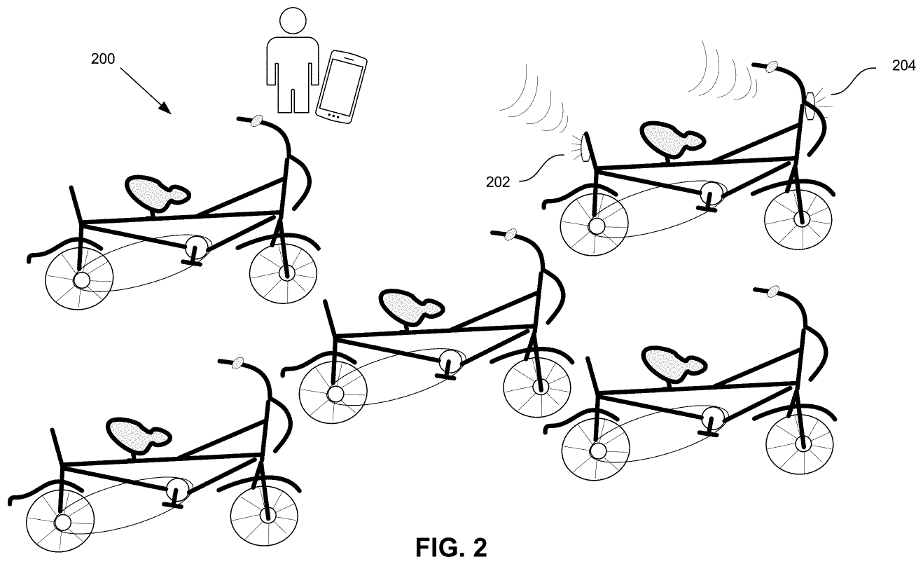

FIG. 2 is an illustration of another embodiment in which at least one of a plurality of bicycles 200 can be identified by remotely activating one or more lights 202, 204, such as a headlight 206 and/or taillight 204. Since in some countries, such as Holland, bikes are required by law to have a headlight and a taillight in order to be ridden at night, a receiver unit could be combined with one or both of these lights 204, 206. The lights 204, 206 could then server their existing function plus the function of helping to locate the bike when a signal is sent by the rider, such as through a cell phone app or when a key fob is pressed. In some embodiments, if the receiver is integrated into a light that does not also house a battery, such as certain bicycle lights that are powered by a dynamo, then the receiver unit may be powered by a separate battery.

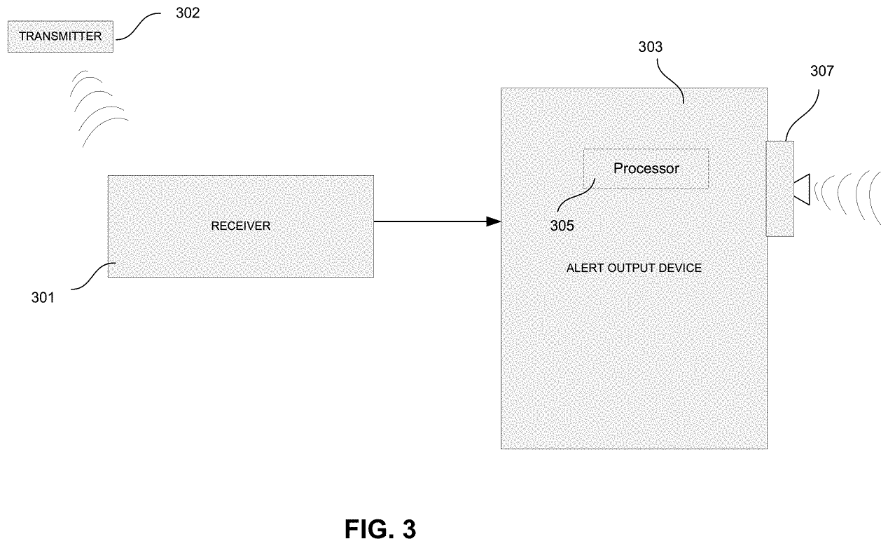

FIG. 3 is a simplified block diagram of the components of a personal transportation vehicle, such as a bicycle. A receiver 301 receives signals wirelessly transmitted from a transmitter 302. The receiver 301 is coupled to an alert output device 303. As noted above, the alert output device 303 may be any device that is capable of producing an alert, such as a bell, a light, a horn, etc. In addition, the alert output device 303 may include a processor 305 for processing the received signal and determining the manner and duration for which the output is to be provided from the alert output device 303. That is, the processor 305 may be coupled to an audio or visual output device, such as a horn, bell, light, etc. that produces an audio and/or visual alert upon activation by the processor 305. The processor 305 may be simply responsive to the input signal received by the receiver 301, or the processor may have a programmable array of responses with which to respond to the signal received by the processor 305 from the receiver 301. For example, the receiver 301 may be “triggered” by receipt of a particular signal from the transmitter 302. Upon being triggered, the receiver 301 outputs a signal to the processor 305. The processor 305 may combine the input from the receiver with other environmental factors to produce an appropriate alert response based on a programmed set of instructions, artificial intelligence or other processing of the set of environmental inputs and the triggering signal from the receiver 301.

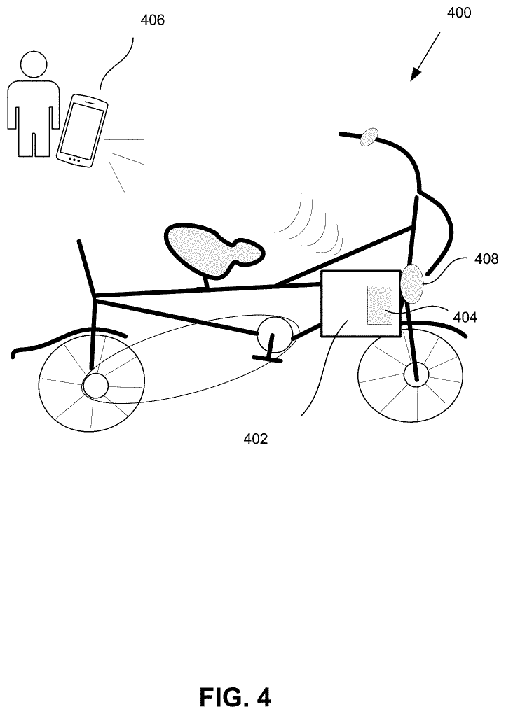

FIG. 4 is an illustration of an embodiment in which a frame lock 402 having receiver 404 can receive signals from a remote source 406 to both unlock the bicycle 400 and also make either an audible or visual indication to identify the bicycle of interest. The receiver 404 could be combined with a frame lock 402. In one related embodiment, turning a key to lock the bike 400 could turn on the receiver 404 and turning the key to unlock the bike 400 could turn-off the receiver 404. Alternatively, because the key is always retained in the lock when the unit is unlocked, the receiver 404 could be turned on when the key is removed and turned off when the key is inserted. In either embodiment, this could result in significant extension of battery life. In addition, while the transmitter 406 could remain as a separate cell phone or key fob, one other embodiment of combining the locator system with a frame lock 402 would be to integrate the transmitter with the device used to lock the bicycle. The frame lock 402 could be integrated with an audible or visual alert output device 408 that could assist in identifying the bicycle 400 when the receiver 404 receives signals from the user's transmitter 406, such as a cell phone or key fob.

Once the frame lock has incorporated with a chirping/blinking locator beacon, it is possible to add a motion sensor as well. This would allow the frame lock to also act as an anti-theft device, sounding an alarm if the bike is moved while it is locked. This would be entirely separate from the bike-locator invention because it would not rely on a transmitter and receiver. However, it would be complementary to the bike locator invention because it would share with the locator the audible and visual locator beacon pieces of the locator.

Each of the features described above for pedal-bicycles could also apply to e-bikes. In particular, bike sharing programs generally have e-bikes which use all of these same accessories (bell, lights, frame lock). In particular, a keyless version of a frame lock for locking and unlocking the bicycle is commonly included with e-bikes used in bike sharing programs.

E-Bikes used as part of a bike sharing program generally have a GPS beacon and radio receiver/transmitter already built in for bluetooth and cellular. The receiver portion of the locator could be combined with these existing radio receivers in the bike. In addition, in some embodiments, rather than the transmitter unit as a key fob, a cell phone and app used by the rider to reserve, find and unlock the e-bike could initiate the transmission of location signals to the e-bike. Such functionality could be integrated into the same application on the phone or into a difference application that is purchased or downloaded separately.

E-Bikes also have one important feature that traditional pedal-bikes do not. That is, a powerful internal battery. Accordingly, a separate battery is not needed for the receiver and its beacon signaling method (audible signals and lights). Because the receiver of an e-bike does not have to be accessible for fresh battery changes, this also potentially allows the receiver to be permanently mounted in a hard-to-access place, such as inside a bike frame tube.

In yet another embodiment, the elements described above for e-bikes are applicable to folding electric scooters, especially those used in scooter sharing programs. While many scooters used in programs today do not have alert output devices, such as bells and lights, and the wheel lock is a bit different, features, such as bells and lights, provide a safety advantage on scooters, which when combined with the location feature, could make such features cost effective.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A personal transportation vehicle comprising:
a) an alert output device;
b) a receiver coupled to the alert output device mounted on the personal transportation vehicle such that the receiver receives signals to initiate an alert output.

2. The personal transportation vehicle of claim 1, wherein the personal transportation vehicle is a bicycle.

3. The personal transportation vehicle of claim 2 wherein the bicycle is an electric bicycle.

4. The personal transportation vehicle of claim 1, further including an alert output device coupled to the receive for receiving an output signal from the receiver and responding with an alert output.

5. The personal transportation vehicle of claim 4, wherein the alert output device comprises an audio alert.

6. The personal transportation vehicle of claim 5, wherein the audio alert is a bell

7. The personal transportation vehicle of claim 5, wherein the audio alert is a horn.

8. The personal transportation vehicle of claim 4, wherein the alert output device comprises a visual alert.

9. The personal transportation vehicle of claim 8, wherein the visual alert is a light.

10. The personal transportation vehicle of claim 8, wherein the visual alert is a headlight mounted on the personal transportation vehicle.

11. The personal transportation vehicle of claim 8, wherein the visual alert is a taillight mounted on the personal transportation vehicle.

12. A personal transportation vehicle identification system comprising:
a) a personal transportation vehicle comprising:
i. an alert output device;
ii. a receiver coupled to the alert output device mounted on the bicycle such that the receiver receives signals to initiate an alert output.
b) a transmitter configured to transmit signal to the receiver in response to input from a user.

13. The personal transportation vehicle of claim 12, wherein the personal transportation vehicle is a bicycle.

14. The personal transportation vehicle of claim 13, wherein the bicycle is an electric bicycle.

15. The personal transportation vehicle of claim 12, further including an alert output device coupled to the receive for receiving an output signal from the receiver and responding with an alert output.

16. The personal transportation vehicle of claim 13, wherein the alert output device comprises an audio alert.

17. The personal transportation vehicle of claim 13, wherein the alert output device comprises a visual alert.

18. The personal transportation vehicle of claim 12, wherein the transmitter is a key fob.

19. The personal transportation vehicle of claim 12, wherein the transmitter is a cellular telephone.

20. The personal transportation vehicle of claim 19, wherein the transmitter within the cellular phone is responsive to an application running on the cellular telephone.

21. The personal transportation vehicle of claim 1 or 12, wherein the personal transportation vehicle is a motorized scooter.

22. The personal transportation vehicle of claim 1 or 12, further comprising a security system, wherein the security system comprises the receiver.
